(19) United States
(12) Patent Application Publication
(10) Pub. No.: US 2022/0363159 A1
(43) Pub. Date: Nov. 17, 2022

(54) CHARGING DEVICE FOR ELECTRICAL MACHINES

(71) Applicant: FREE2MOVE ESOLUTIONS S.P.A, Milano (IT)

(72) Inventor: Carlalberto GUGLIELMINOTTI, Milano (IT)

(73) Assignee: FREE2MOVE ESOLUTIONS S.P.A, Milano (IT)

(21) Appl. No.: 17/755,612

(22) PCT Filed: Oct. 29, 2020
(86) PCT No.: PCT/IB2020/060159

§ 371 Date: May 3, 2022

(30) Foreign Application Priority Data
Nov. 4, 2019 (IT) 102019000020336

(51) Int. Cl. B60L 53/63; B60L 53/30

(52) U.S. Cl. CPC B60L 53/63; B60L 53/305

(57) ABSTRACT

Charging device for electrical machines, including a body fixable to a wall and including at least a first connector, accessible from outside, to electrically connect the device and the user to allow the electric charge of the device, a second connector placed within the body to electrically connect the first connector and a first external electric grid to define a type of mode two charging, and to electrically connect the first connector and a second external electric grid to define a mode three type of charging, and adjustment apparatus to limit the supply of electrical energy from the first connector within a maximum threshold value of electrical energy in relation to the instantaneous consumption of the first external electric grid during device use.

The present invention relates to a charging device for electrical machines of the type specified in the preamble of the first claim.

In particular, the present invention relates to a device, for example wall box or column or other, for the charging electric machines whole or in part, such as, for example, PHEV and BEV vehicles, rather hybrid or full electric.

Similar devices are described in patent applications WO 2011/019855 EP 2 800 226 A1, GB 2 525 068 A and WO 2012/120353 A2.

As is known, the advent of electric or hybrid vehicles in the automotive market has given rise to the problem of charging such vehicles.

In this regard, various solutions have been developed which provide for charging stations including columns or wall boxes easily accessible by users in order to charge their car with simplicity.

Such solutions, can be adopted in the public sphere, for example in the space occupied by service stations, or in domestic environment, for example in the vicinity of the space assigned to parking of vehicles.

Among the various types of devices provided for charging electrical machines, at least two different types are distinguished: mode two or mode three charging devices.

The mode two charging devices, whether they are wall boxes or columns, are devices that include a connection plug to an external electrical network, for example domestic, and which essentially does not require professional installation by the use of a dedicated line and can be used and can be used as “Plug & Play” appliance. For example, the plug is of the Schuko type or similar.

This is possible thanks to the fact that the mode two charging devices are typically compliant with IEC 61851-1 standard, with predetermined maximum current limit depending mainly on the specific local legislation, for example between 6-10A for countries such as Italy, Switzerland, France and many others. These devices, with a power supply of 10 A, can usually obtain maximum power supplies of 2.3 kW. Mode three charging devices, on the other hand, are powered by a dedicated line, which is exclusively without the possibility of using cable and plug configurations, as for the mode two charging.

Furthermore, mode three charging devices, typically compliant with the IEC 61851-1 standard, are static or even dynamic devices, which are capable of varying the output power of electric energy, with a current limit usually set at 32 A for a maximum power of approximately 7.4 kW with monophase power supply or 22 kW with three-phase power supply.

The known technique described includes some important drawbacks.

In particular, the two and three mode charging devices, responding to completely different supply needs, are not interchangeable.

One of the most relevant problems is, in this regard, given by the fact that while the connection of mode two devices can be made by any user with any electrical network, the mode three devices need a dedicated network and qualified operators.

Therefore, if you intend to switch from mode two charging to mode three charging for obvious advantages of practicality and/or available power, it is necessary to change the entire device.

In addition to the above, while the mode three charging devices can allow, if correctly configured, to manage the power supply according to the type of machine being charged, the mode two devices are static and do not allow to adjust the power load in relation to the machine.

This characteristic can lead, therefore, to the block of external electrical network power supply, for example if the global power request to the external electric network is excessive, as occurs in common domestic electrical networks thanks to the maximum current (or magneto-thermal) protections placed at downstream of electricity meters.

In this situation, the technical task underlying the present invention is to project a charging device for electrical machines capable of obviating at least part of the aforementioned drawbacks.

Within the scope of said technical task, an important aim of the invention is to device for recharging machines which is versatile and allows the same device to be easily converted in such a way as to access, as desired, mode two or mode three charging.

Another important purpose of the invention is to create a device that allows the electric power supply for mode two charging in a dynamic way, which is depending on the type of electric machine being charged.

The technical task and the specified aims are achieved by a charging device for electrical machines as claimed in the attached claim 1. Preferred technical solutions are highlighted in the dependent claims.

The features and the advantages of the invention are clarified below by the detailed description of preferred embodiments of the invention, with reference to the accompanying figures, in which:

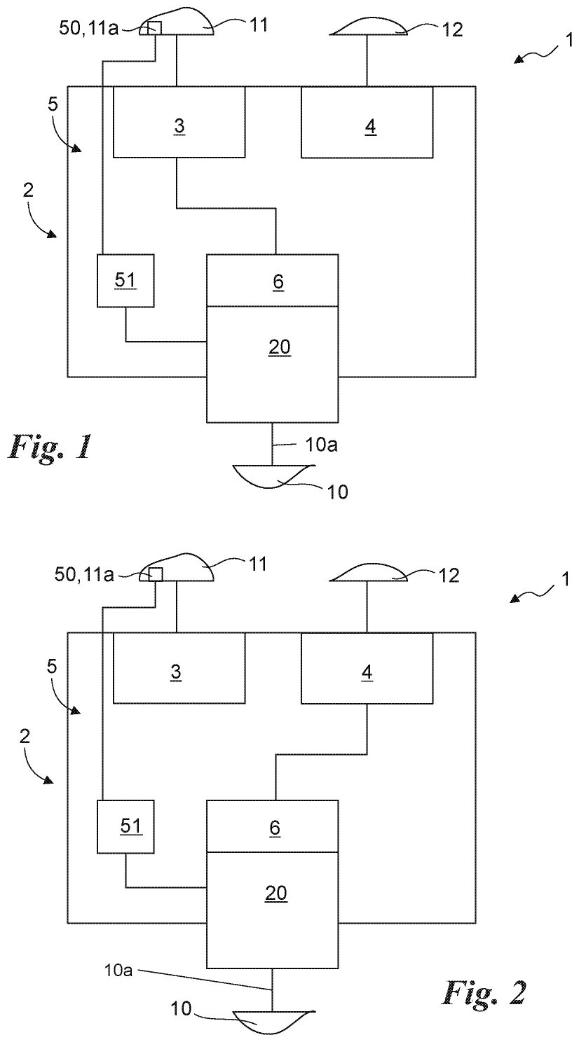

The FIG. 1 shows a functional diagram of a charging device for electric machines according to the invention wherein the first connector is powered by the second connector and operatively connected exclusively to it to achieve a mode two charging;

The FIG. 2 illustrates a functional diagram of a charging device for electrical machines according to the invention wherein the first connector is powered by the third connector and operatively connected exclusively to it to achieve a mode three charging;

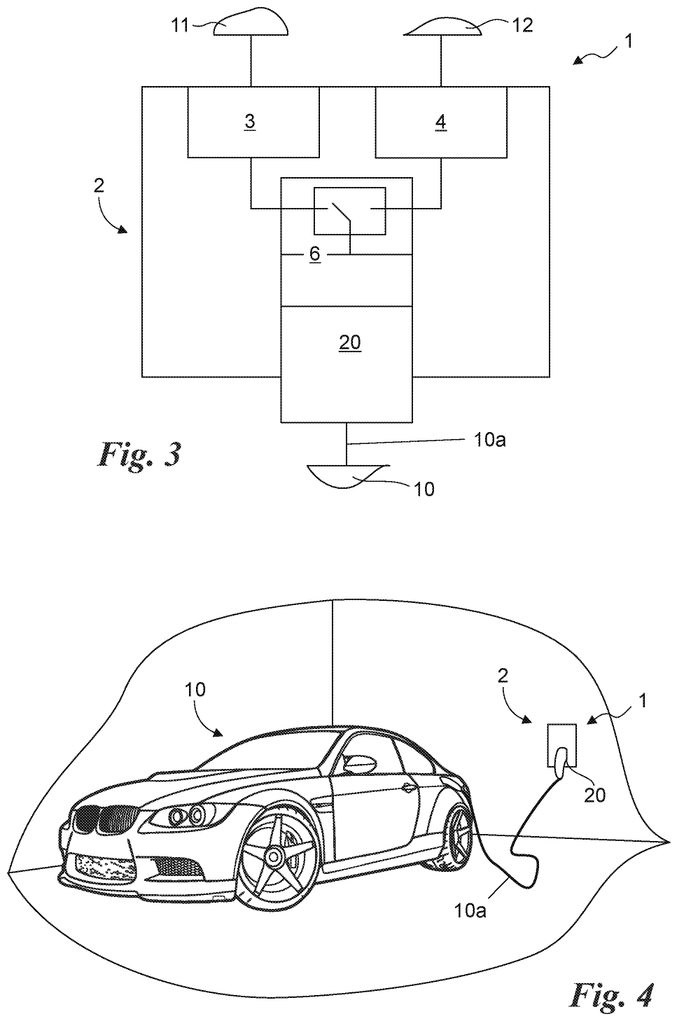

The FIG. 3 is a functional diagram of a charging device for electrical machines according to the invention wherein the first connector is operatively connected both to the second connector and to the third connector and the control means allow selecting the type of power supply; and

The FIG. 4 represents an example of charging a car connected to the charging device for electric machines according to the invention.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first” “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the drawings, the charging device for electrical machines according to the invention is globally indicated with the number 1.

The device 1 is used for the charging of electric machines 10.

These machines 10 can be cars or other apparatuses operating by means of an electrical power supply. Preferably, the machines 10 are vehicles, for example of the road type, such as electric or at least partly electric motor vehicles.

For example, machines 10 are PHEV and BEV vehicles, such as hybrids or full electric.

The device comprises a body 2. The body 2 substantially defines a support structure or a casing suitable for sustaining, supporting and/or containing the components of the device 1.

The body 2 is preferably constrainable to a wall. This face can be a wall, or he ground itself, or even a ceiling.

In this sense, for example, the body 2 can define a wall box constrainable to a wall. These types of devices are known to those skilled in the art and substantially include a closed container accessible through one or more connectors. The wall boxes are often used mainly in domestic environment.

Or, body 2 can define a column constrainable to the ground. Charging columns are also known to those skilled in the art and, in particular, employees especially in the external charging stations.

In any case, the body 2 includes at least a first connector 20.

The first connector 20 is preferably accessible from the outside. It is, therefore, configured to electrically connect the device 1 and the machine 10, for example the electric vehicle or as previously defined, in such a way as to allow the charging of the electrical machine 10.

With the term configured, it is not intended that the first connector 20 is necessarily directly connected to the machine 10. In fact, preferably, the first connector 20 is connected to the machine 10 through connection plugs 10a known to the person skilled in the art.

The type of the connection used by the first connector 20 may also be various types. For example, the first connector 20 can be a female or, more preferably, a male connector.

Moreover, it can be of type 1, type 2 or other according to the choice. The connection technologies are known to those skilled in the art, as are the connection apparatuses between machines 10 and device 1, obviously compatible with the first connector 20.

The device 1 also includes a second connector 3.

The second connector 3 is preferably housed on the body 2. In this sense it is meant that the second connector 3 can be partially placed inside the body 2, or it can be housed on the body 2 in such a way as to be entirely accessible or mainly from the external, for example constrained in correspondence of the external surface of the body 2.

The second connector 3 is also preferably configured to electrically connect the first connector 20 and a first electrical grid 11.

The first electrical grid 11 is preferably an external electrical grid to the device 1. It can be any domestic electrical network, or an industrial electric grid.

In any case, the first electrical grid 11 can be accessible through, for example, wall sockets arranged in the environment that houses the device 1.

In fact, preferably, the second connector 3 is preferably suitable for allowing the smooth link between the first electrical grid 11 and the device 1. The second connector 3 could therefore include a cable with a plug of any type, for example schuko, operatively connected to the first connector 20 and connectable to a socket of the first electrical grid 11.

Basically, the second connector 3 could be similar to a power supply connector of any household appliance currently on the market.

In particular, the second connector 3 is connected to the first electrical grid 11 in such a way as to define a type of mode two charging.

Mode two charging, as known to those skilled in the art and described above, preferably defines a supply wherein the predetermined maximum current limit is between 6-10 A or is regulated according to the specific local legislation. In particular, with a power supply of 10 A, it is usually possible to obtain maximum power supplies of 2.3 kW.

In this sense, the type of charge can be static, or by predefined supplied electric energy. Or, advantageously, the supply of electricity by the first connector 20 can be adjusted in such a way as to render the conduct of the device 1, in mode two charging, dynamic.

In this regard, preferably, the device 1 includes adjustment means 5.

The adjustment means 5 are preferably configured to limit the supply of electrical energy from the first connector 20.

In particular, they are designed to keep the electricity supplied by the first connector 20 within a maximum threshold value of electrical energy in relation to the instantaneous consumption of the first external electric grid 11 during the use of the device 1.

Naturally, when we talk about “limiting” the supply of electrical energy by the adjustment means 5, it is meant that the adjustment means 5 acting on the demand for absorption by the machine 10 and, indirectly, limit the supply from the first connector 20. Basically, in this sense, it is taken for granted that, as occurs in common plants, such as the charger-on-board, present on electric vehicles, the machine 10 is able to control its own absorption and the means of regulation 5, communicating with the user 10 in such a way as to require from the machine 10 a lower absorption and, consequently, limiting the supply of the device 1.

The absorption control devices on vehicles are well known, and moreover conventional, especially for electric cars which provide for mode three charging, Preferably, in detail, the adjustment means include at least one sensor 50 and a processor 51.

The sensor 50 is configured to detect, moment by moment, the overall electrical energy supplied by the first electric grid 11.

It is important to specify that with the term “electrical energy” it is assumed that it is dependent on certain supply parameters and that, in a generic sense, when we talk about control of the electrical energy it is implicitly meant that the control is applied to current, and/or voltage, and/or electrical power supplied.

In particular, the sensor 50 is operatively connected to a meter 11a

The meter 11a is preferably a common electric energy meter, for example of the type present in any domestic environment or building supplied with electrical energy. Therefore, the meter 11a is at least enabled to monitor the supply of electrical energy preferably in the first electric grid 11.

Like every meter 11a, for example, the meter 11a allows counting the instantaneous supply of electrical power.

Preferably, the sensor 50 detects, for example, this value and forwards it to the processor 51.

The sensor 50 can therefore coincide with the meter 11a itself. The processor 51 is, therefore, operationally connected to the first connector 20 and to the sensor 50.

Furthermore, it is configured to determine the maximum threshold value of electrical energy in relation to the overall electrical energy detected by the sensor 50. To do this, the processor 51 is equipped with an upgradeable firmware, within which a total energy value that can be supplied from the first electric grid 11. Once the maximum value that can be supplied from the electric grid 11 is set, for example for common residences this value can be 3 kW, the processor 51 can manage the maximum threshold value of energy supplied by the first connector so that the total power supplied by the electric grid 11 not exceeds the maximum value.

If for example, the first connector 20 supplies electricity to 2.3 kW of power, but the total power supplied by the first electric grid 11 reaches values of 3.5 kW, the processor 51 modulates the supply from the first connector 20 in such a way as to be within 3 kW, for example by reducing the power from 2.3 kW to 1.8 kW.

Therefore, the adjustment means 5 could include, as previously mentioned, an electronic power or current or other controller, located on the machine 10, capable of dynamically varying, instant by instant, in relation to the consumption of the first electric grid 11, the demand for energy by the machine 10 and, therefore, the supply of electricity to the first connector 20.

The device 1, moreover, can include a further advantageous feature. Preferably, it comprises a third connector 4.

The third connector 4 is preferably placed on the body 2. It too, like the second connector 3, can be partially housed inside the body 2, or it can be housed on the body 2 in such a way that it can be fully or mainly accessible from the outside, for example constrained at the external surface of the body 2.

The third connector 4 is also preferably configured too electrically connect the first connector 20 and a second electric grid 12.

The second electric grid 12 is preferably an electric grid external to the device 1. It is preferably a dedicated electrical grid, for example industrial. In any case, the second electric grid 12 can be accessible through, for example, connections made ad hoc by operators trained in the construction of electric systems.

In fact, preferably, the third connector 4 is preferably suitable for allowing the connection between the second electric grid 12 and device 1 in situations wherein the supply of electricity is particularly onerous, or ore expensive than a simple conventional domestic network.

In particular, the third connector 4 is connected to the second electric grid 12 in such a way as to define a mode three charging type.

The mode three charging, as known to those skilled in the art and described above, preferably defines a supply wherein the predetermined maximum current limit is approximately equal to 32 A or is regulated according to the specific local legislation. In particular, with a power supply of 32 A, it is usually possible to obtain maximum power supplies of 7.4 kW for single-phase voltage supply or 22 kW for three-phase voltage supply.

Therefore, in the preferred embodiment, the device 1 includes the second connector 3 and the third connector 4 in such a way as to allow the definition of two different types of charging.

Preferably, in particular, the first connector 20 is powered by exclusively one choice between the second connector 3 and the third connector 4.

In this regard, the device 1 can be configured in various ways.

In a first configuration, the first connector 20 can be selectively powered between second connector 3 and third connector 4 depending on the actual electrical between connectors 2 and 3 or 2 and 4.

In this sense, the device 1 can provide that, if configured for mode two charging, only the second connector 3 and the first connector 2 are mutually electrically connected, as shown in FIGS. 1-2.

Alternatively, in a second configuration, both connectors 3, 4 can be simultaneously electrically connected to the first connector 2, but the device 1 can include control means 6.

In this configuration, the control means 6 can include a switch suitable for selecting exclusively one of the available power supply channels, for example one between the channel determined b connectors 2 and 3 and the channel defined by connectors 2 and 4, as shown in FIG. 3.

Therefore, the control means 6 are arranged between the connectors 3,4 and the first connector 2. In other words, the control means 6 are arranged upstream of the first connector 2, such as between the external electrical networks 11, 12 or one of them, and the first connector 20.

The control means 6, when present, however are mainly configured to allow the selection, on command of predetermined values of maximum energy delivered by the first connector 20.

Basically, the control means 6 allow to control manually the maximum supply of electricity. Preferably, differently from the adjustment means 5, the control means 6 include a manual knob operable preferably by an operator in such a way as to select predetermined supply values.

In particular, the control means 6 comprise a switch configured to vary the maximum intensity of current supplied by the first connector 20 at least between 5 A and 35 A.

The switch could also be configured to vary, also or alternatively, the maximum power supplied by the first connector 20 at least between 1.3 kW and 7.6 kW for single-phase voltage supply or between 3 kW and 22 kW for three-phase voltage supply.

The control means 6 could include a graduated switch wherein, it is selectable, for example, certain supply values, for example controlled in current.

Eventually, the device 1 preferably does not comprise batteries suitable for charging the machine 10, in particular a battery having a capacity greater than 10%, better than 20%, even better than 50% of the capacity of the battery of the machine 10. The device 1 may comprise preferably only micro batteries with other purposes.

Basically, the operation of the device 1 can be constrained to the wall, creating a wall box, or to the ground, creating a charging column.

Furthermore, the device 1 may be exclusively connected to a home network, through the second connector 3, and used for mode two charging.

If necessary, an operator 2 can intervene on the adjustment means 5 in such a way as to set the firmware of the processor 51 in relation to the values detected by the sensor 50 at the meter 11a.

In addition, the operator can, upon request, disconnect the second connector 3 from the first connector 2 and connect the third connector 4 to the second connector 2 in such a way as to configure the device for mode three charging.

If the control means 6 are present, the operator can select the current delivery values in such a way as to conform to the configured charging type. For example, if in mode two charging, the control means 6 select a supply with current equal to 6 A or 10 A, or if in charging mode three the control means 6 select a supply with current equal to 32 A.

As previously described, if the control means 6 include also a switch, the operator can select the power supply line without having to disconnect one or the other connector 3, 4.

The device 1, according to the invention achieves important advantages.

In fact, the device 1 allows to integrate two different charging modes allowing the selection, through the control means 6, or through the intervention of a qualified operator, of the type of charging without having to replace the device 1 entirely.

Furthermore, different from the known art, the mode two charging can take place in a dynamic and controlled manner. Therefore, the device 1 can not cause blocks of the first electric grid 11.

The invention is susceptible of variants falling within the scope of the inventive concept defined by the claims.

In this context, all the details can be replaced by equivalent elements and the materials, shapes and dimensions can be any.

1. A charging device for electrical machines comprising:
a body that can be attached to a wall and including at least a first connector, accessible from the outside, configured to electrically connect said device and said machine in such a way as to allow the electric charging of said machine,
a second connector housed on said body and configured to electrically connect said first connector and a first external electric grid in order to define a ‘mode two’ type of charging,
and
adjustment means configured to limit the supply of electrical energy from said first connector within a maximum threshold value of electrical energy in relation to the instantaneous consumption of said first external electric grid during the use of said device.

2. The device according to claim 1, wherein said adjustment means include at least one sensor configured to detect, instant by instant, the overall electrical energy supplied by said first electric grid and a processor operatively connected to said first connector and said sensor and configured to determine said maximum threshold value of electrical energy in relation to said overall electrical energy.

3. The device according to claim 2, wherein said sensor is operationally connected to a first meter configured to monitor the delivery of the electricity within said first electric grid.

4. The device according to claim 1, comprising a third connector placed on said body and configured to electrically connect said first connector and a second external electric grid in such a way to define a type of mode three charge.

5. The device according to claim 1, wherein said first connector is powered exclusively by one of a choice between said second connector and said third connector.

6. The device according to claim 1, comprising control means arranged upstream of said first connector and configured to allow the selection, on command, of predetermined values of maximum energy delivered by said first connector.

7. The device according to claim 6, wherein said control means comprise a switch configured to vary the maximum intensity of current supplied by said first connector at least between 5 A and 35 A.

8. The device according to claim 1, wherein said control means comprise a switch configured to vary the maximum power supplied by said first connector at least between 1.3 kW and 7.6 kW A for single-phase power supply or between 3 kW and 22 kW for three-phase power supply.

9. The device according to claim 1, wherein said body defines a wall box that can be constrained to the wall.

10. The device according to claim 1, wherein said body defines a column constrainable to the ground.
